(19) United States
(12) Patent Application Publication
(10) Pub. No.: US 2021/0027278 A1
(43) Pub. Date: Jan. 28, 2021

(54) SYSTEM AND METHOD FOR VISUALIZING DATA CORRESPONDING TO A PHYSICAL ITEM

(71) Applicant: Sajjad Rizvi, London (GB)

(72) Inventor: Sajjad Rizvi, London (GB)

(21) Appl. No.: 16/522,138

(22) Filed: Jul. 25, 2019

(51) Int. Cl. G06Q 20/34

(52) U.S. Cl. CPC G06Q 20/352; G06K 7/10297; G06Q 20/341

(57) ABSTRACT

A system and method may visualize data related to a payment device and various physical objects. A payment device such as a credit card including an RFID may be placed near a frontend display system that then calls a backend visualization system to show a visual representation of deterministic and probabilistic data related to the payment device and the physical object(s). Additional physical objects may be placed near the display system and identified. The visualization may then be refined based on that additional physical object. Further physical objects may be read by the frontend system to present more detailed visualizations that relate the payment device and the additional physical objects.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Data forms the backbone of the information age. With increased computing power and communication capabilities, data may be collected on virtually anything at any time and may be distributed almost anywhere instantly. However, data without analysis and interpretation may prompt more questions than it reveals answers. In raw form, data rarely provides actionable insight.

Collection of data about physical objects is also fraught with difficulty. Most physical objects are not designed with data collection in mind, nor do most physical objects include sensors, displays, or other hardware to enable a user to learn more about the object itself. Further still, most physical objects, even those designed with sensors for data collection, have no access to data that may be related to the object or the capability of analyzing related data to provide further insight about the object. For example, a credit card or other payment device may be related to an immense amount of data regarding transactions using the payment device, but the payment device itself cannot show a user relationships among that transaction data or relationships to other, non-transactional data.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

A payment device such as a credit card including an RFID tag may be placed near a frontend display system that then calls a backend visualization system to show a visual representation of deterministic and probabilistic data related to the payment device. Additional physical objects may be placed near the display system and identified. The visualization may then be refined based on that additional physical object. Further physical objects may be read by the frontend system to present more detailed visualizations that relate the payment device and the additional physical objects.

A computer-implemented method may receive a first signal from a first contactless component corresponding to a payment device. The first signal may include an identification for the payment device. The method may then display payment network account data for transactions using the payment device. At least one of the transactions may include an identification for the payment device. The method may also receive a second signal including an identification for a physical object from a second contactless component corresponding to a physical object. Based on the identification for the physical object, the method may identify one or more parameters that correspond to both the payment device and the physical object. The method may then refine the displayed payment network account data to display one or more visualizations of at least a portion of the displayed payment network account data. The portion of the displayed payment network account data corresponds to the one or more parameters. The method may be performed using one or more processors.

A system may include a processor and a memory in communication with the processor. The memory may store instructions, that when executed by the processor, cause the processor to execute various instructions to visualize data corresponding to a user's payment network account data. The memory may include instructions to receive a first signal from a first contactless component corresponding to a payment device. The first signal may include an identification for the payment device. The memory may also include instructions to display payment network account data for transactions using the payment device. At least one of the transactions may include an identification for the payment device. Further instruction may receive a second signal including an identification for a physical object from a second contactless component corresponding to a physical object. Based on the identification for the physical object, executed instructions may identify one or more parameters that correspond to both the payment device and the physical object. Instructions to refine the displayed payment network account data may then display one or more visualizations of at least a portion of the displayed payment network account data. The portion of the displayed payment network account data corresponds to the one or more parameters.

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 shows an illustration of an exemplary payment system for intelligently visualizing transaction data corresponding to a payment device;

FIG. 2A shows a first view of an exemplary payment device for use with the system of FIG. 1;

FIG. 2B shows a second view of an exemplary payment device for use with the system of FIG. 1;

FIG. 3 is an illustration of a hierarchical arrangement of data for refining visualizations related to transactions of a payment device;

FIG. 4 is an illustration of one embodiment of a machine learning architecture for use with the system of FIG. 1;

FIG. 5 is an illustration of another embodiment of a machine learning architecture for use with the system of FIG. 1;

FIG. 6 is a flowchart of a method for intelligently visualizing transaction data corresponding to a payment device;

FIGS. 7A, 7B, and 7C illustrate different views for placement of a payment device and physical objects on a table configured to facilitate the embodiments described herein;

FIGS. 8A, 8B, and 8C illustrate different views of a media wall for visualizing transaction data corresponding to a payment device and various physical objects; and

FIGS. 9A and 9B illustrate different views of the media wall within an immersive media hub environment, as described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DETAILED DESCRIPTION

The embodiments described herein may describe a technical solution to the technical problem of visualizing data related to a physical device. The embodiments solve this problem by tracking an identification for the physical device to digital transactions including the identification for deterministic data. Further, the embodiments may analyze other transactions that do not include the identification using neural networks and other artificial intelligence methods for probabilistic data. The deterministic and probabilistic data may then be further analyzed in combination and visualized hierarchically such that a user may explore all data related to the physical device.

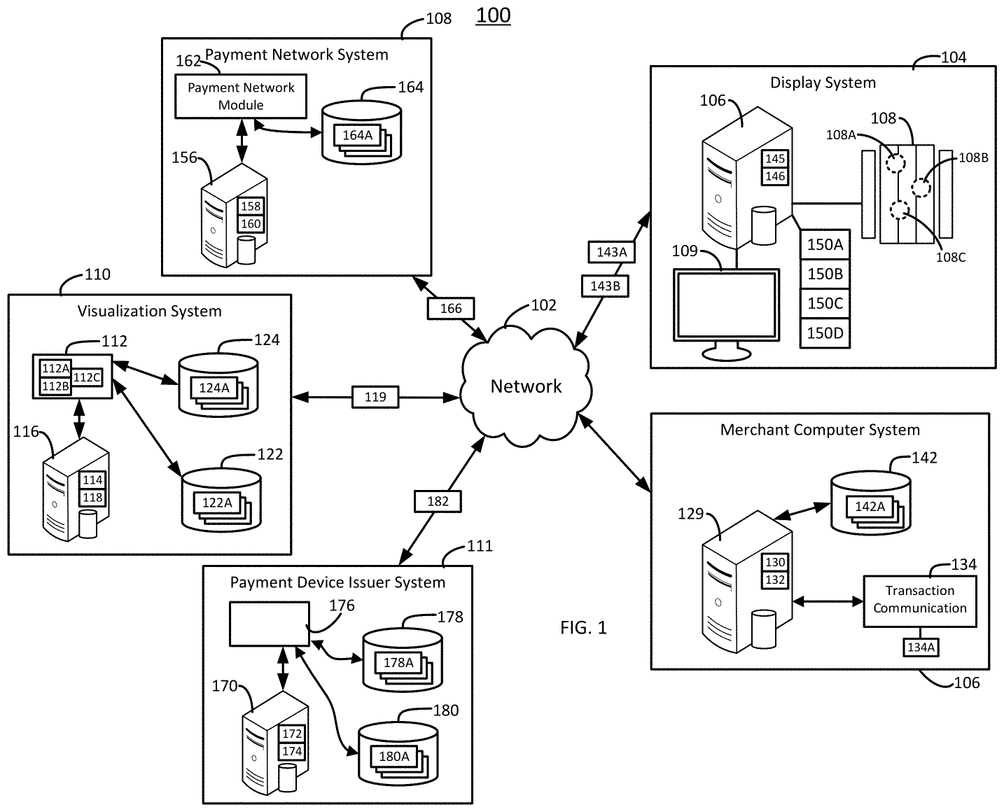

FIG. 1 generally illustrates one embodiment of a system 100 for visualizing data related to a physical device such as a credit card. The system 100 may include a computer network 102 that links one or more systems and computer components. In some embodiments, the system 100 includes a visualization system 104, a merchant computer system 106, a payment network system 108, and a payment device issuer system 111.

The network 102 may be described variously as a communication link, computer network, internet connection, etc. The system 100 may include various software or computer-executable instructions or components stored on tangible memories and specialized hardware components or modules that employ the software and instructions in a practical application to visualize data related to a physical device for a plurality of transactions by monitoring transaction communications between users and merchants as well as other parties, as described herein.

The various modules may be implemented as computer-readable storage memories containing computer-readable instructions (i.e., software) for execution by one or more processors of the system 100 within a specialized or unique computing device. The modules may perform the various tasks, steps, methods, blocks, etc., as described herein. The system 100 may also include both hardware and software applications, as well as various data communications channels for communicating data between the various specialized and unique hardware and software components.

Networks are commonly thought to comprise the interconnection and interoperation of hardware, data, and other entities. A computer network, or data network, is a digital telecommunications network which allows nodes to share resources. In computer networks, computing devices exchange data with each other using connections, i.e., data links, between nodes. Hardware networks, for example, may include clients, servers, and intermediary nodes in a graph topology. In a similar fashion, data networks may include data nodes in a graph topology where each node includes related or linked information, software methods, and other data. These data networks may be visualized to show interconnections between computer-implemented events related to a physical device such as a credit card or other device showing deterministic and probabilistic transactions related to the physical device.

It should be noted that the term “server” as used throughout this application refers generally to a computer, other device, program, or combination thereof that includes a processor and memory to process and respond to the requests of remote users across a communications network. Servers send their information to requesting “clients.” The term “client” as used herein refers generally to a computer, program, other device, user and/or combination thereof that is capable of processing and making requests and obtaining and processing any responses from servers across a communications or data network. A computer, other device, set of related data, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

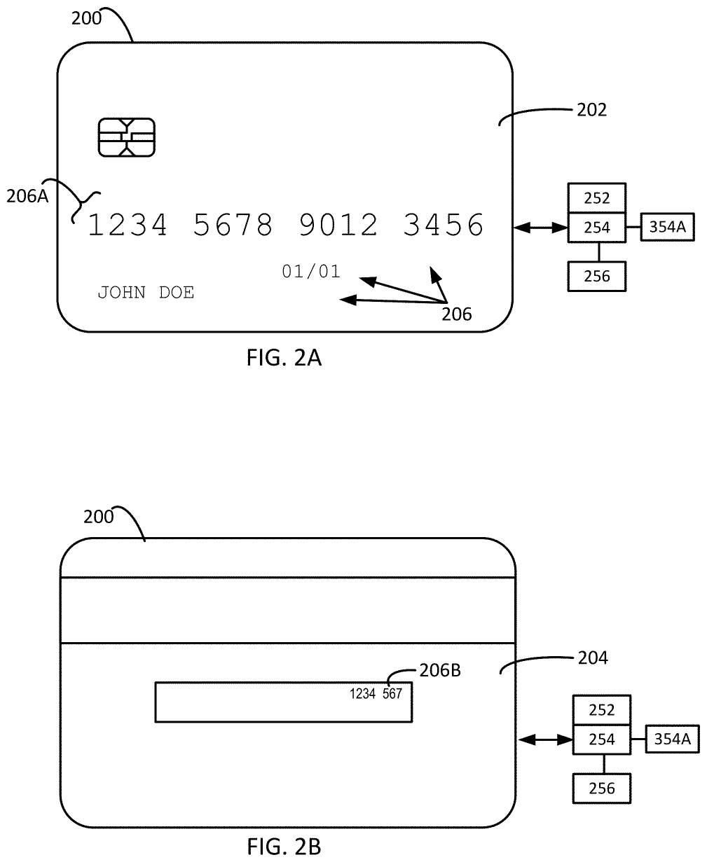

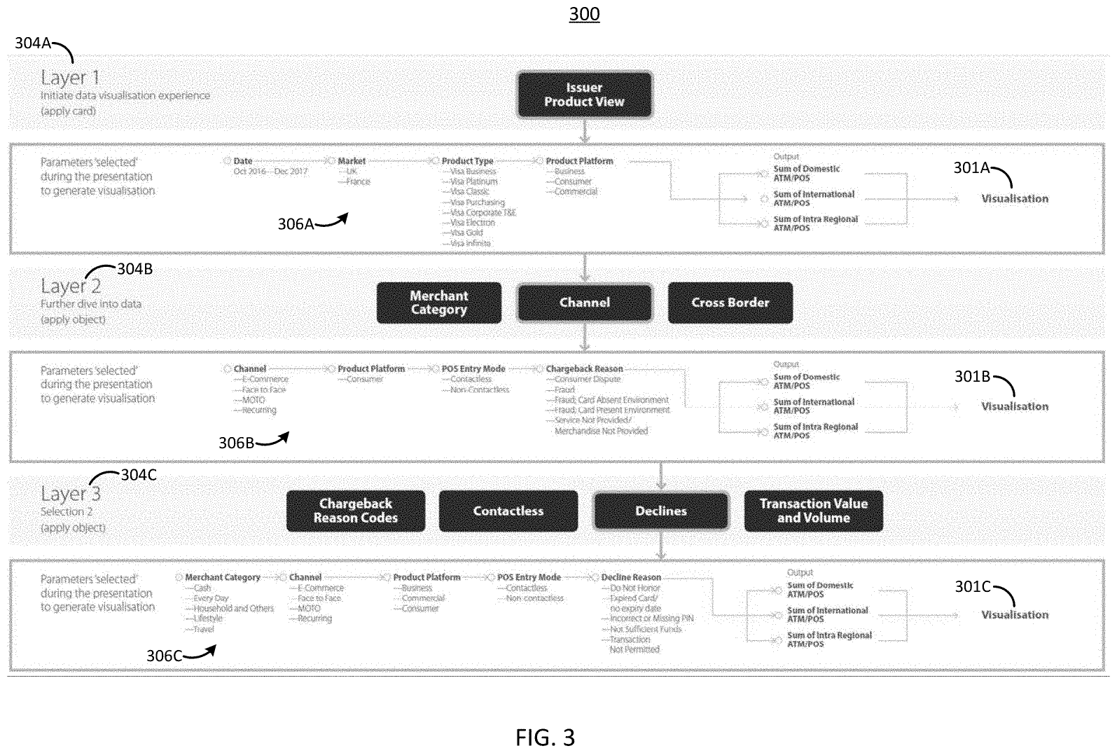

The visualization system 110 may include one or more instruction modules including a visualization module 112 that, generally, may include instructions to cause a processor 114 of a visualization server 116 to functionally communicate with a plurality of other computer-executable steps or sub-modules, e.g., sub-modules 112A, 112B, 112C, and components of the system 100 via the network 102 to create a visualization (301A, 301B, 301C; FIG. 3) related to the payment device 200 (FIGS. 2A and 2B). For example, sub-modules 112A, 112B, 112C may include instructions to compare data 300 (FIG. 3) to benchmark data or averages of the data 300 and create visualizations (301A, 301B, 301C; FIG. 3) to stimulate a user's interest and appreciation of the data's value. These modules 112A, 112B, 112C may include instructions that, upon loading into the server memory 118 and execution by one or more computer processors 114, identify one or more transaction nodes 119 including linked data describing payment or other types of transactions between various entities (e.g., users and/or merchants, etc.) that may be processed by the payment network system 108. For example, sub-modules may include a first machine learning module 112A, a second machine learning module 112B, a data integration module 112C, etc. A first data repository 122 may store payment network transaction data 122A for all entities of the system 100. In some embodiments, further data repositories may correspond to different types of payment network transaction data 122A or sub-components of the payment network transaction data 122A (e.g., a merchant, an account holder, a transaction region, transaction type, a time of day, a merchant and/or customer type, a physical device identification, a payment device type, a transaction amount, cardholder name, cardholder account number, and other payment network account data 164A, etc.).

Various other data 124A may be received and/or derived by the visualization system 110 and stored in a second data repository 124 and used by the system 100 as described herein. For example, the second data repository may be used to store electronic wallet transaction details 124A from an electronic wallet system or other method of electronic or computer-based payment.

The merchant computer system 106 may include a computing device such as a merchant server 129 including a processor 130 and memory 132 including components to facilitate transactions with the display system 104 and/or a payment device 200 (FIG. 2) via other entities of the system 100. In some embodiments, the memory 132 may include a transaction communication module 134. The transaction communication module 134 may include instructions to send merchant messages 134A to other entities (i.e., 104, 108, 110, 111) of the system 100 to indicate a transaction has been initiated with the display system 104 and/or payment device 200 including payment device data and other data as herein described. The merchant computer system 106 may also include a transaction repository 142 and instructions to store payment and other transaction data 142A within the transaction repository 142. In some embodiments, the merchant computer system 106 may send payment device identification data 143A corresponding to a payment device 200 (FIG. 2) and/or physical object identification data 143B other data it received during a transaction to the payment network system from the display system 104.

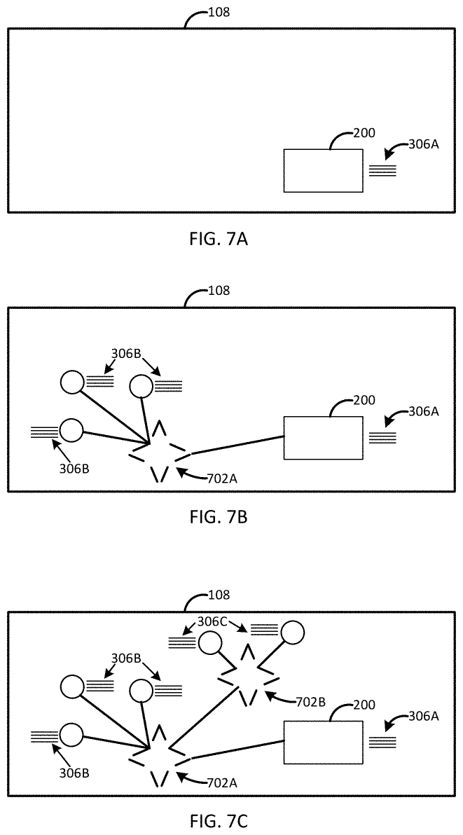

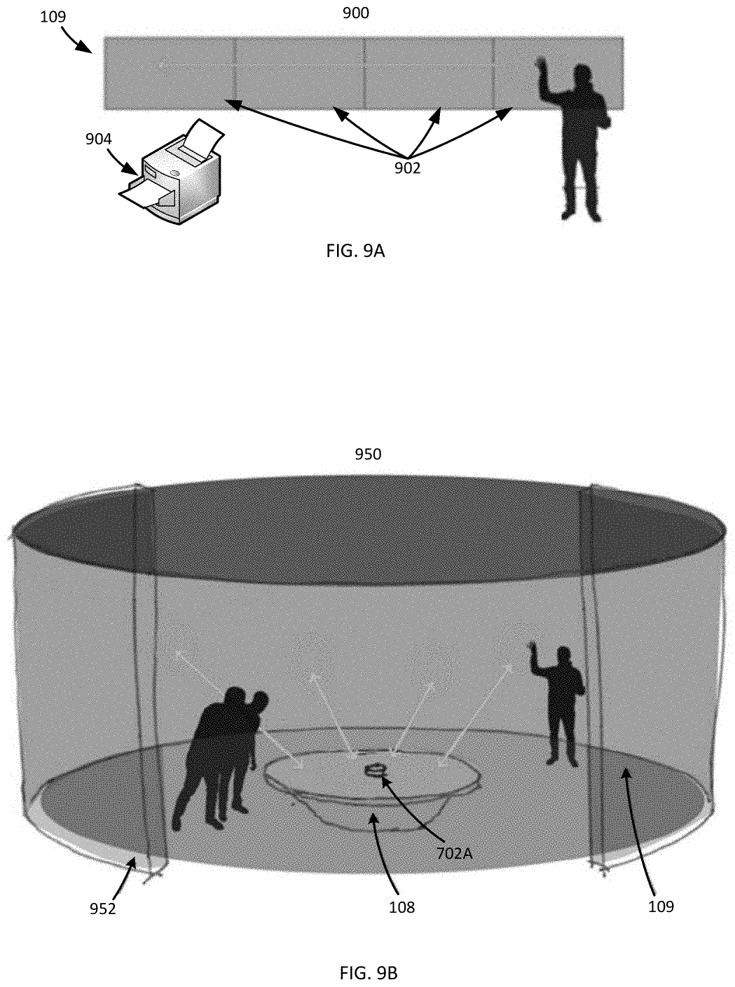

A display system 104 may include a display system server 106 including a processor 145 and memory 146. Physically, the display system 104 may include a table 108 or other surface capable of receiving a physical object and a media wall 109 to display visualizations as described herein. The media wall 109 may partially encompass the table 108. For example, with brief reference to FIGS. 9A and 9B, a welcome area 900 may include one or more touchscreen monitors 902 and a printer 904. The printer 904 may allow a user to print a physical object (e.g., physical objects 702A, 702B of FIGS. 7A and 7B) having an RFID tag or other mode of contactless communication. In some embodiments, the printer 904 may be a three-dimensional printer for printing a three-dimensional physical object upon which an RFID tag including identification data or other data may be affixed for communication with the table 108 or other component of the system 100 as described herein. The table 108 may be at the center of a room 950 with the walls 952 of that room having one or more touchscreen monitors 902 comprising the media wall 109. The walls 952 and media wall 109 may encompass the table 108 by at least 300 degrees. The table 108 and media wall 109 of the display system may each include a server, a mobile computing device, a smartphone, a tablet computer, a Wi-Fi-enabled device or other personal computing device capable of wireless or wired communication, a thin client, or other known type of computing device. The memory 146 may include various modules including instructions that, when executed by the processor 145 control the functions of the display system 104 generally and integrate the display system 104 into the system 100 in particular. For example, some modules may include an operating system 150A, a browser module 150B, a communication module 150C, a receiving module 150D. The receiving module may include processor-executable instructions to receive a signal from contactless component of a physical object such as payment device identification data 143A and/or physical object identification data 143B. In some embodiments, the receiving module 150D may include an RFID receiver or instructions to implement an RFID receiver. In further embodiments, the receiving module 150D may define a plurality of “hotspots” 108A, 108B, 108C on the table 108. A hotspot may be a physical location where a user may obtain access to the system 100 using RFID or other contactless technology, via a wireless local area network (WLAN) using a router connected to an internet service provider. Placement of a payment device 200 or physical object within a hotspot 108A, 108B, or 108C may cause the table 108 to send payment device identification data 143A and/or physical object identification data 1436 for the item placed within the hotspot. The table 108 and media wall 109 may each include a touch-sensitive or touchscreen display for displaying and manipulating visualizations, as described herein.

The payment network system 108 may include a payment server 156 including a processor 158 and memory 160. The memory 160 may include a payment network module 162 including instructions to facilitate payment between parties (e.g., one or more users, merchants, etc.) using the payment system 100. The module 162 may be communicably connected to an account holder data repository 164 including payment network account data 164A. The payment network account data 164A may include any data to facilitate payment and other funds transfers between system entities (i.e., 104, 106, 110, and 111). For example, the payment network account data 164A may include identification data, account history data, payment device data, etc. The module 162 may also include instructions to send payment messages 166 to other entities and components of the system 100 in order to complete transactions between users and/or merchants.

With brief reference to FIGS. 2A and 2B, an exemplary payment device 200 may take on a variety of shapes and forms. In some embodiments, the payment device 200 is a traditional card such as a debit card or credit card. In other embodiments, the payment device 200 may be a fob on a key chain, an NFC wearable, or other device. In other embodiments, the payment device 200 may be an electronic wallet where one account from a plurality of accounts previously stored in the wallet is selected and communicated to the system 100 to execute the transaction. As long as the payment device 200 is able to communicate securely with the system 100 and its components, the form of the payment device 200 may not be especially critical and may be a design choice. For example, many legacy payment devices may have to be read by a magnetic stripe reader and thus, the payment device 200 may have to be sized to fit through a magnetic card reader. In other examples, the payment device 200 may communicate through near field communication or other contactless form of communication and the form of the payment device 200 may be virtually any form. For example, the payment device may include a Radio-Frequency Identification (RFID) tag 252 that is capable of being read by the display system 104 and processed by the visualization system 110 to produce one or more visualizations related to the payment device 200 and/or other physical objects. Of course, other forms may be possible based on the use of the card, the type of reader being used, etc.

Physically, the payment device 200 may be a card and the card may have a plurality of layers to contain the various elements that make up the payment device 200. In one embodiment, the payment device 200 may have a substantially flat front surface 202 and a substantially flat back surface 204 opposite the front surface 202. Logically, in some embodiments, the surfaces 202, 204 may have some embossments 206 or other forms of legible writing including a personal account number (PAN) 206A and the card verification number (CVN) 206B. In some embodiments, the payment device 200 may include data corresponding to the primary account holder, such as payment network account data 164A for the account holder. A memory 254 generally and a module 254A in particular may be encrypted such that all data related to payment is secure from unwanted third parties. A radio-frequency identification (RFID) tag 252 may be communicably coupled to a communication interface 256. The communication interface 256 may include instructions to facilitate sending payment device identification data 143A, such as payment network account data 164A, a payment payload, a payment token, a physical object identification, account identification, physical object identification data 143B such as a serial number, product or service name, UPC code, etc., or other data to identify the payment device 200 and/or a physical object to one or more components of the system 100 via the network 102.

A payment device issuer system 111 may also include a payment device issuer server 170 including a processor 172 and memory 174. The memory may include a payment device issuer module 176 including instructions to facilitate payment to the merchant computer system 106 using the payment system 100. The module 176 may be communicably connected to an issuer transaction data repository 178 including issuer transaction data 178A. The issuer transaction data 178A may include data to facilitate payment and other funds transfers to/from the merchant from the payment device issuer system 111. For example, the issuer transaction data 178A may include merchant identification data, user account history data, physical object/payment device data, etc. The module 176 may also be communicably connected to a cardholder account data repository 180 including cardholder account data 180A. The module 162 may also include instructions to receive payment messages 166 from the payment network system 108 and may include the transaction node 119 in order to complete transactions related to the physical object between users and/or merchants and better manage user and merchant funds account balances to complete transactions.

With reference to FIG. 3, the payment network transaction data 122A and other data 124A (collectively referred to herein as data 300) may be hierarchically structured within the repositories 122, 124, respectively, to provide increasingly detailed visualizations (301A, 301B, 301C) related to the payment device 200 as additional physical objects are placed within RFID range of the display system 104 and interpreted or analyzed by the visualization system 110. The data 300 may include hierarchical layers (i.e., a first data layer 304A, a second data layer 304B, a third data layer 304C, etc.). Each layer may be a refinement of the layer above it. For example, the second data layer 304B may be a refinement of the first data layer 304A and the third data layer 304C may be a refinement of the second data layer 304B. One or more modules of the visualization system 110 may include instructions to select one or more parameters (i.e., first data layer parameters 306A, second data layer parameters 306B, third data layer parameters 306C, etc.), and generate a visualization (i.e., a first data layer visualization 301A, a second data layer visualization 301B, a third data layer visualization 301C, etc.) from the selected parameters. Successive placements of physical objects within RFID or other identification range of the display system 104 may further refine the visualization based on the new deterministic and probabilistic information that is related to the additional physical object and the selected parameters.

The first data layer parameters 306A may include dates or a date range for transactions and other items related to the payment device identification data 143A and/or the physical object identification data 143B, a market or region for the transactions, a product type involved in the transaction (e.g., a business or personal account for the payment device 200), and a product platform such as business, consumer, or commercial. Additional first data layer parameters 306A may include different totals related to domestic, international, and/or intra-regional transactions.

The second data layer parameters 306B may be related to merchant categories, channels, and cross border data related to the transactions. In some embodiments, the second data layer parameters 306B may include a channel (e.g., e-commerce, face-to-face, mail order/telephone order, and recurring transactions), a product platform, a point-of-sale entry mode (contactless or non-contactless), and chargeback reasons (e.g., disputes, fraud, service or merchandise not provided, etc.). Additional second data layer parameters 306B may include different totals related to domestic, international, and/or intra-regional transactions.

The third data layer parameters 306C may be related to chargeback reason codes, contactless or non-contactless, declines, and transaction value and volume. In some embodiments, the third data layer parameters 306C may include a merchant category (case, every day purchases, household and other goods, lifestyle, travel, etc.), channel, product platform, point-of-sale entry mode, and decline reasons (e.g., do not honor, expired card, incorrect/missing PIN, insufficient funds, impermissible transactions). Additional third data layer parameters 306C may include different totals related to domestic, international, and/or intra-regional transactions.

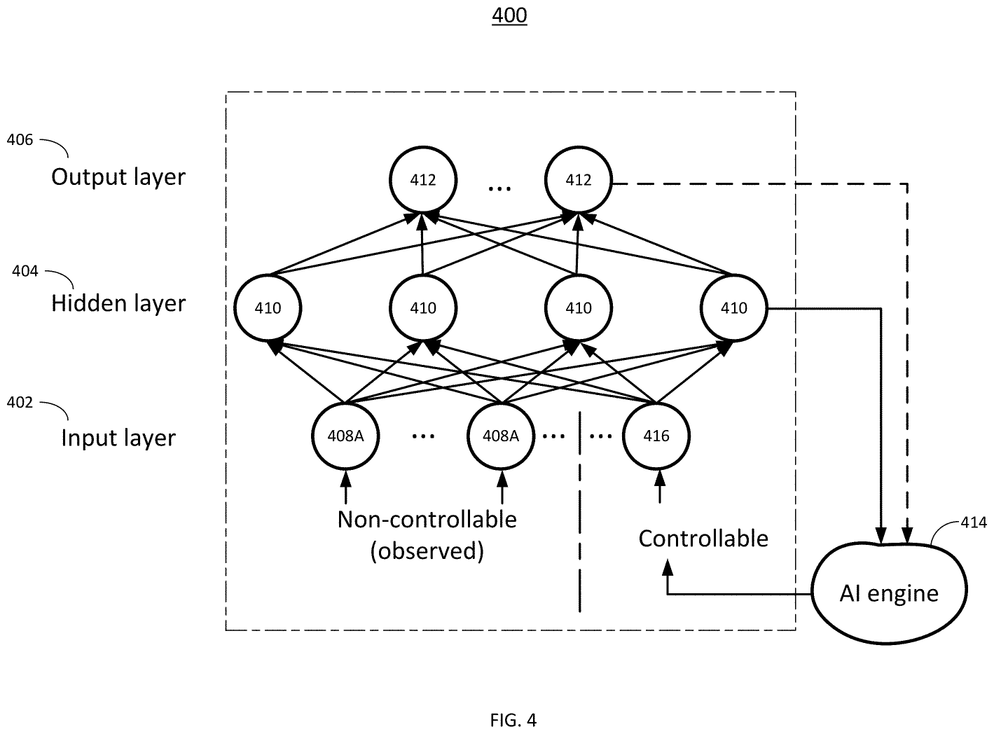

With reference to FIG. 4, a machine learning (ML) architecture 400 may be used in a first machine learning module 112A and/or a second machine learning module 1126 of the visualization system 110 in accordance with the current disclosure to analyze probabilistic data related to the payment device 200 and physical objects. In some embodiments, the first machine learning module 112A and/or the second machine learning module 112B of the visualization system 110 may include instructions for execution on the processor 114 that implement the ML architecture 400. The ML architecture 400 may include an input layer 402, a hidden layer 404, and an output layer 406. The input layer 402 may include inputs 408A, 408B, etc., coupled to the data integration module 112C and represent those inputs that are observed from actual customer and merchant data in transactions related to the payment device 200. The hidden layer 404 may include weighted nodes 410 that have been trained for the transactions being observed. Each node 410 of the hidden layer 404 may receive the sum of all inputs 408A, 408B, etc., multiplied by a corresponding weight. The output layer 406 may present various outcomes 412 based on the input values 408A, 408B, etc., and the weighting of the hidden layer 404. Just as a machine learning system for a self-driving car may be trained to determine hazard avoidance actions based on received visual input, the machine learning architecture 400 may be trained to analyze a likely outcome for a given set of inputs based on thousands or even millions of observations of previous customer/merchant transactions. For example, the ML architecture 400 may be trained to identify transactions that are most likely fraudulent, to identify accounts that are associated with high-net-worth payment device users, to show trends for the user of the payment device 200 compared to baseline or average trends for other users of other payment devices, refine this data by time, location, other physical objects, etc.

During training of the machine learning architecture 400, a dataset of inputs may be applied and the weights of the hidden layer 410 may be adjusted for the known outcome associated with that dataset. As more datasets are applied, the weighting accuracy may improve so that the outcome prediction is constantly refined to a more accurate result. In this case, the first data repository 122 including payment network transaction data 122A for entities of the system 100 may provide datasets for initial training and ongoing refining of the machine learning architecture 400.

Additional training of the machine learning architecture 400 may include the an artificial intelligence engine (AI engine) 414 providing additional values to one or more controllable inputs 416 so that outcomes may be observed for particular changes to the payment network transaction data 122A or other data 124A. The values selected may represent different data types such as selected cryptographic methods applied to the payment network account data 164A, merchant messages 134A, payment device identification data 143A, physical object identification data 143B, and other alternative data presented at various points in the transaction process and may be generated at random or by a pseudo-random process. By adding controlled variables to the transaction process, over time, the impact may be measured and fed back into the machine learning architecture 400 weighting to allow capture of an impact on a proposed change to the process in order to optimize the accuracy of visualizations (301A, 301B, 301C, etc.). Over time, the impact of various different data at different points in the transaction cycle may be used to predict an outcome for a given set of observed values at the inputs layer 402.

After training of the machine learning architecture 400 is completed, data from the hidden layer may be fed to the artificial intelligence engine 414 to generate values for controllable input(s) 416 to optimize the accuracy of the visualizations or even predictive uses of the payment device 200 or other physical objects. Similarly, data from the output layer may be fed back into the artificial intelligence engine 414 so that the artificial intelligence engine 414 may, in some embodiments, iterate with different data to determine further visualizations via the trained machine learning architecture 400.

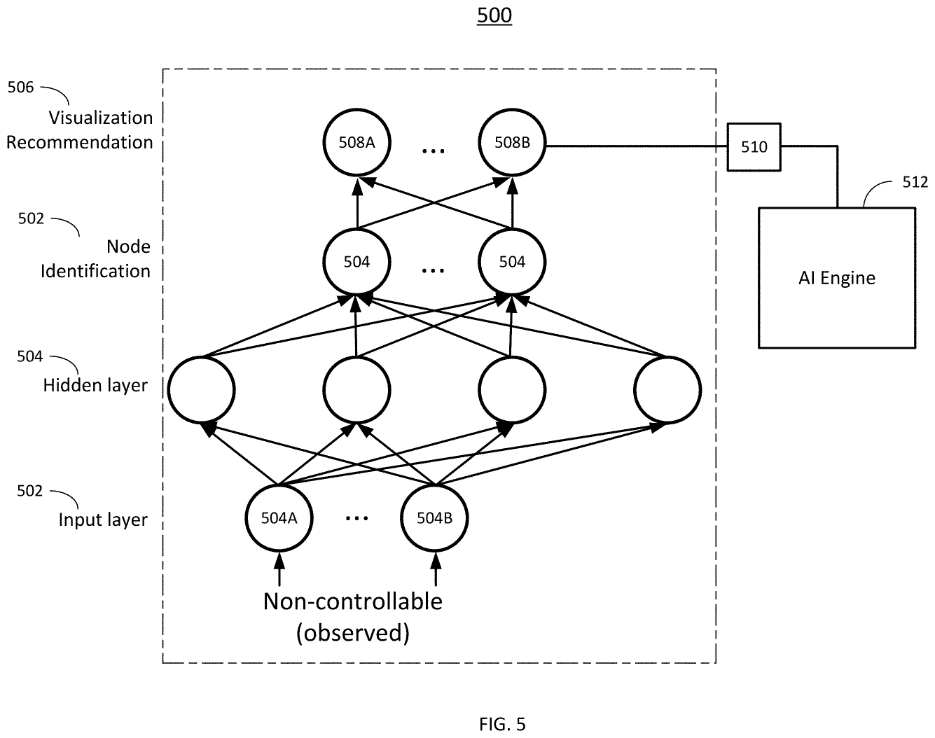

With reference to FIG. 5, in other embodiments, the machine learning architecture 400 and artificial intelligence engine 414 may include a second instance of a machine learning architecture 500 and/or an additional node layer may be used. In some embodiments, a node identification layer 502 may determine a visualization node 504 from observed inputs 504A, 504B. A visualization recommendation layer 506 with outputs 508A, 508B, etc., may be used to generate visualization recommendations 510 to an artificial intelligence engine 512, which in turn, may modify one or more of the visualizations.

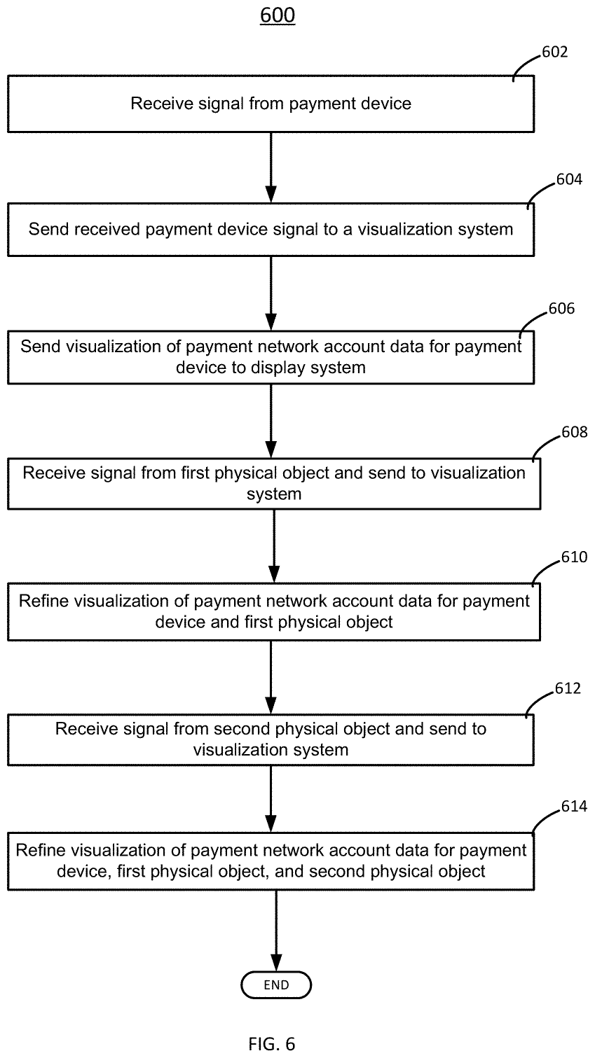

With reference to FIG. 6, a method 600 may visualize data corresponding to physical objects placed on or near a table device 108 (FIGS. 7A, 7B, 7C) on a media wall 109 (FIGS. 1, 8A, 8B, 8C, 9A, 9B). Each step of the method 600 is one or more computer-executable instructions (e.g., modules, blocks, steps, stand-alone or sequences of instructions, etc.) performed on a processor of a server or other computing device (e.g., a visualization system 104, a merchant computer system 106, a payment network system 108, and a payment device issuer system 111, or other computer system illustrated in FIG. 1 and/or described herein) which may be physically configured to execute the different aspects of the method. Each step may include execution of any of the instructions as described in relation to the method 600 and system 100 as part of the data visualization systems and methods described herein or other component that is internal or external to the system 100. While the below blocks are presented as an ordered set, the various steps described may be executed in any particular order to complete the methods described herein.

At block 602, the method 600 may receive a signal from a first physical object, e.g., the payment device 200. In some embodiments, and with reference to FIG. 7A, the payment device 200 may be within RFID range of or placed on the table 108. In further embodiments, the payment device 200 may be placed within a hotspot 108A, 108B, 108C of the table 108. The receiving module 150D may receive the RFID signal from and RFID tag 252 of the payment device 200 including payment device identification data 143A. Of course, other information related to the payment device 200 or the payment network account data 164A corresponding to the payment device 200 may be included with the RFID signal that is received by the receiving module 150D. In other embodiments, with reference to FIG. 9A, when the first physical object or payment device 200 does not include an RFID or similar contactless tag for communicating identification data to the system 100, the first physical object may be printed at a printer 904. Printing the physical object may also cause the system 100 to link an RFID tag or other contactless communication device for the printed item (e.g., physical object 702A, 702B, FIGS. 7B and 7C) to identification data 143A, 143B. The contactless communication device may then be placed on the physical object 702A, 702B for communication with the system 100 and implementation of the embodiments described herein.

At block 604, the method 600 may send the received RFID signal data to one or more other systems or components of the system 100 in response to receiving the RFID signal. In some embodiments, the method 600 may cause the display system 104 generally and the table 108 in particular to send the payment device identification data 143A or other information related to the payment device 200 or the payment network account data 164A corresponding to the payment device 200 (e.g., the physical object identification data 143B) to the visualization system 110. In other embodiments, the display system 104 may send the data to another component of the system 100 (e.g., the payment network system 108).

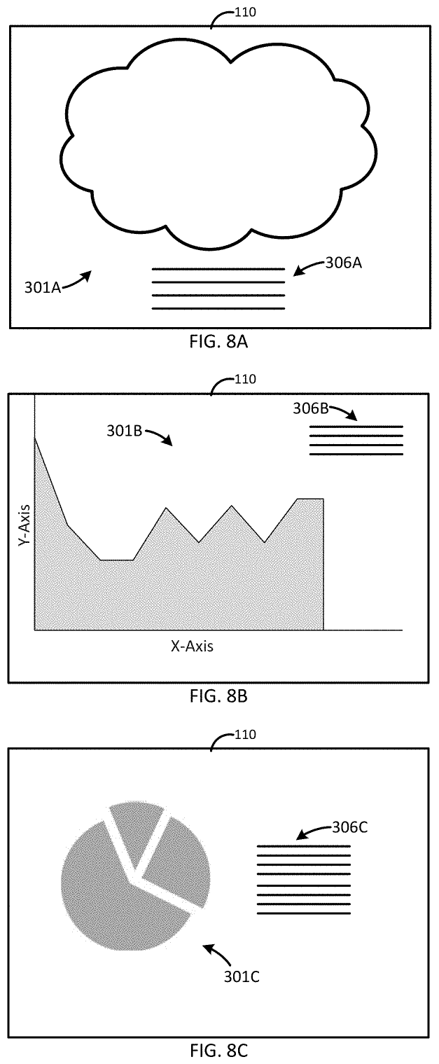

At block 606, the method 600 may send data and instructions to the display system 104 to visualize one or more aspects of the payment device 200 and the related payment network account data 164A within the table 108 and/or the media wall 109 in response to receiving the payment device identification data 143A from the display system 104. In some embodiments, the visualization module 112 generally and the first machine learning module 112A, the second machine learning module 112B, and the data integration module 112C may analyze deterministic and probabilistic data related to the received payment device identification data 143A to determine one or more first data layer parameters 306A. The method 600 may then, with reference to FIG. 8A, send data corresponding to a first data layer visualization 301A corresponding to the analyzed data and including one or more first data layer parameters 306A to the display system 104 for display at the table 108 and/or the media wall 109.

At block 608, the method 600 may send physical object identification data 143B corresponding to a first physical object 702A to one or more other systems or components of the system 100 in response to placement of the first physical object 702A (FIG. 7B) on the table 108 or within signal range of the table 108 and the receiving module 150D. In some embodiments, the method 600 may cause the display system 104 generally and the table 108 in particular to send the physical object identification data 143B or other information related to the first physical object 702A or the payment network account data 164A corresponding to the first physical object 702A to the visualization system 110. In other embodiments, the display system 104 may send the data to another component of the system 100 (e.g., the payment network system 108).

At block 610, the method 600 may send data and instructions to the display system 104 to visualize one or more aspects of a combination of the payment device 200 and the first physical object 702A and the related payment network account data 164A. In some embodiments, block 610 includes refining the previously-displayed payment network account data corresponding to the payment device. In further embodiments, block 610 includes executing instructions of the visualization module 112 to create a second data layer visualization 301B within the table 108 or the media wall in response to receiving both the payment device identification data 143A and the physical object identification data 143B from the display system 104. In some embodiments, the visualization module 112 generally and the first machine learning module 112A, the second machine learning module 112B, and the data integration module 112C may analyze deterministic and probabilistic data related to the received payment device identification data 143A and physical object identification data 143B to determine one or more first or second data layer parameters 306A, 306B for display with the visualization 301B. The method 600 may then, with reference to FIG. 8B, send data corresponding to a second data layer visualization 301B corresponding to the analyzed data and including one or more first data layer parameters 306A and/or second data layer parameters 306B to the display system 104 for display at the table 108 and/or the media wall 109. In some embodiments, block 610 may include selection of one or more first data layer parameters 306A and/or second data layer parameters 306B within a touchscreen component of either the table 108 or media wall 109, along with deterministic and probabilistic data analysis to create the first data layer visualization 301A and/or the second data layer visualization 301B. Selection of different first or second data layer parameters 306A, 306B within the visualization may also cause the system 100 to change the visualizations 301A, 301B within one or more of the table 108 or media wall 109.

At block 612, the method 600 may send physical object identification data 143B corresponding to a second physical object 702B to one or more other systems or components of the system 100 in response to placement of the second physical object 702B (FIG. 7C) on the table 108 or within signal range of the table 108 and the receiving module 150D. In some embodiments, the method 600 may cause the display system 104 generally and the table 108 in particular to send the physical object identification data 143B for the second physical object 702B or other information related to the second physical object 702B or the payment network account data 164A corresponding to the second physical object 702B to the visualization system 110. In other embodiments, the display system 104 may send the data to another component of the system 100 (e.g., the payment network system 108).

At block 614, the method 600 may send data and instructions to the display system 104 to visualize one or more aspects of a combination of the payment device 200, the first physical object 702A, the second physical object 702B, and the related payment network account data 164A. In some embodiments, block 614 includes executing instructions of the visualization module 112 to create a third data layer visualization 301C (FIG. 7C) within the table 108 or the media wall 109 in response to receiving the payment device identification data 143A, and the physical object identification data 143B for both the first physical object 702A and the second physical object 702B from the display system 104. In some embodiments, the visualization module 112 generally and the first machine learning module 112A, the second machine learning module 112B, and the data integration module 112C may analyze deterministic and probabilistic data related to the received payment device identification data 143A and physical object identification data 143B to determine one or more first, second, or third data layer parameters 306A, 306B, 306C for display with the visualization 301C. The method 600 may then, with reference to FIG. 8C, send data corresponding to a third data layer visualization 301C corresponding to the analyzed data and including one or more first data layer parameters 306A and/or second data layer parameters 306B and/or third data layer parameters 306C to the display system 104 for display at the table 108 and/or the media wall 109. In some embodiments, block 614 may include selection of one or more first data layer parameters 306A and/or second data layer parameters 306B and/or third data layer parameters 306C within a touchscreen component of either the table 108 or media wall 109, along with deterministic and probabilistic data analysis of the visualization module 112 to create the first data layer visualization 301A and/or the second data layer visualization 301B and/or third data layer visualization 301C. Selection of different first, second, and third data layer parameters 306A, 306B, 306C may also cause the system 100 to change the visualizations 301A, 301B, 301C within one or more of the table 108 or media wall 109.

Thus, the embodiments described herein may visualize data related to a payment device 200 and various physical objects. A payment device such as a credit card including an RFID may be placed near a frontend display system 104 that then calls a backend visualization system 110 to show a visual representation of deterministic and probabilistic data related to the payment device and the physical object(s). Additional physical objects may be placed near the display system and identified. The visualization may then be refined based on that additional physical object. Further physical objects may be read by the frontend system to present more detailed visualizations that relate the payment device and the additional physical objects.

Additionally, certain embodiments are described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a processor configured using software, the processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method comprising:
receiving a first signal from a first contactless component corresponding to a payment device, the first signal including identification data for the payment device;
displaying payment network account data for transactions using the payment device, at least one of the transactions including identification data for the payment device;
receiving a second signal from a second contactless component corresponding to a physical object, the second signal including identification data for the physical object;
identifying, based on identification data for the payment device and the identification data for the physical object, one or more parameters corresponding to the displayed payment network account data, the one or more parameters corresponding to both the payment device and the physical object; and
refining the displayed payment network account data to display one or more visualizations of at least a portion of the displayed payment network account data, the portion of the displayed payment network account data corresponding to the one or more parameters;
wherein the method is performed using one or more processors.

2. The method of claim 1, wherein the first signal is received at a first hotspot of a table and the second signal is received at a second hotspot of the table.

3. The method of claim 1, wherein the first contactless component and the second contactless component include an RFID tag.

4. The method of claim 3, wherein displaying payment network account data for transactions using the payment device includes analyzing deterministic and probabilistic data corresponding to the received identification data for the payment device.

5. The method of claim 4, wherein refining the displayed payment network account data to display one or more visualizations of at least a portion of the displayed payment network account data includes analyzing deterministic and probabilistic data corresponding to both the received identification data for the payment device and the received identification data for the physical object.

6. The method of claim 5, wherein displaying payment network account data for transactions using the payment device includes displaying one or more first data layer parameters.

7. The method of claim 6, wherein refining the displayed payment network account data to display one or more visualizations of at least a portion of the displayed payment network account data includes displaying one or more first data layer parameters and one or more second data layer parameters.

8. The method of claim 7, wherein refining the displayed payment network account data to display one or more visualizations of at least a portion of the displayed payment network account data includes receiving a selection of one or more first data layer parameters and one or more second data layer parameters.

9. The method of claim 1, wherein displaying the payment network account data for transactions using the payment device includes displaying the payment network account data on a media wall that partially encompasses a table, the table configured to receive the identification data for the payment device and the identification data for the physical object.

10. The method of claim 9, wherein the media wall encompasses the table by at least 300 degrees.

11. A system comprising:
a processor and a memory in communication with the processor, the memory storing instructions, that when executed by the processor, cause the processor to:
receive a first signal from a first contactless component corresponding to a payment device, the first signal including identification data for the payment device;
display payment network account data for transactions using the payment device, at least one of the transactions including identification data for the payment device;
receive a second signal from a second contactless component corresponding to a physical object, the second signal including identification data for the physical object;
identify, based on the identification data for the payment device and the identification data for the physical object, one or more parameters corresponding to the displayed payment network account data, the one or more parameters corresponding to both the payment device and the physical object; and
refine the displayed payment network account data to display one or more visualizations of at least a portion of the displayed payment network account data, the portion of the displayed payment network account data corresponding to the one or more parameters.

12. The system of claim 11, wherein the first signal is received at a first hotspot of a table and the second signal is received at a second hotspot of the table.

13. The system of claim 11, wherein the first contactless component and the second contactless component include an RFID tag.

14. The system of claim 13, wherein the instruction to display payment network account data for transactions using the payment device includes an instruction to analyze deterministic and probabilistic data corresponding to the received identification data for the payment device.

15. The system of claim 14, wherein the instruction to refine the displayed payment network account data to display one or more visualizations of at least a portion of the displayed payment network account data includes an instruction to analyze deterministic and probabilistic data corresponding to both the received identification data for the payment device and the received identification data for the physical object.

16. The system of claim 15, wherein the instruction to display payment network account data for transactions using the payment device includes an instruction to display one or more first data layer parameters.

17. The system of claim 16, wherein the instruction to refine the displayed payment network account data to display one or more visualizations of at least a portion of the displayed payment network account data includes an instruction to display one or more first data layer parameters and one or more second data layer parameters.

18. The system of claim 17, wherein the instruction to refine the displayed payment network account data to display one or more visualizations of at least a portion of the displayed payment network account data includes an instruction to receive a selection of one or more first data layer parameters and one or more second data layer parameters.

19. The system of claim 11, wherein the instruction to display the payment network account data for transactions using the payment device includes an instruction to display the payment network account data on a media wall that partially encompasses a table, the table configured to receive the identification data for the payment device and the identification data for the physical object.

20. The system of claim 19, wherein the media wall encompasses the table by at least 300 degrees.
